(19) United States
(12) Patent Application Publication
(10) Pub. No.: US 2009/0266047 A1
(43) Pub. Date: Oct. 29, 2009

(54) MULTI-TUBE, CAN-ANNULAR PULSE DETONATION COMBUSTOR BASED ENGINE WITH TANGENTIALLY AND LONGITUDINALLY ANGLED PULSE DETONATION COMBUSTORS

(75) Inventors: Ross Hartley Kenyon, Waterford, NY (US); Narendra Digamber Joshi, Schenectady, NY (US); Venkat Eswarlu Tangirala, Niskayuna, NY (US); Anthony John Dean, Scotia, NY (US); Adam Rasheed, Glenville, NY (US); Aaron Jerome Glaser, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/271,070

(22) Filed: Nov. 14, 2008

Related U.S. Application Data
(60) Provisional application No. 60/988,171, filed on Nov. 15, 2007.

(51) Int. Cl. F02C 5/02

(52) U.S. Cl. 60/39.76

(57) ABSTRACT

An engine contains a compressor stage, a pulse detonation combustion stage and a turbine stage. The pulse detonation combustion stage contains at least one pulse detonation combustor which has an inlet portion. The pulse detonation combustor is oriented longitudinally and/or tangentially with respect to a centerline of the engine.

### PRIORITY

This invention claims priority to U.S. Provisional Application 60/988,171 filed on Nov. 15, 2007, the entire disclosure of which is incorporated herein by reference.

### BACKGROUND OF THE INVENTION

This invention relates to pulse detonation systems, and more particularly, to a multi-tube, can-annular pulse detonation combustor based engine.

With the recent development of pulse detonation combustors (PDCs) and engines (PDEs), various efforts have been underway to use PDC/Es in practical applications, such as in aircraft engines and/or as means to generate additional thrust/propulsion. Further, there are efforts to employ PDC/E devices into “hybrid” type engines which use a combination of both conventional gas turbine engine technology and PDC/E technology in an effort to maximize operational efficiency. It is for either of these applications that the following discussion will be directed. It is noted that the following discussion will be directed to “pulse detonation combustors” (i.e. PDCs). However, the use of this term is intended to include pulse detonation engines, and the like.

Because of the recent development of PDCs and an increased interest in finding practical applications and uses for these devices, there is an increasing interest in increasing their operational and performance efficiencies, as well as incorporating PDCs in such a way so as to make their use practical.

In some applications, attempts have been made to replace standard combustion stages of engines with a single PDC. However, because of the forces and stresses involved, relatively large PDCs can be impractical. This is due to the need for very thick wall structures, along with other components, and the need for relatively long PDC tubes to initiate a detonation. The larger the diameter of the PDC the longer the PDC tube needs to be. In many engine applications, this added length is problematic.

Additionally, it is known that the operation of PDCs creates extremely high pressure peaks and oscillations both within the PDC and upstream components, as well as generating high heat within the PDC tubes and surrounding components. Because of these high temperatures and pressure peaks and oscillations during PDC operation, it is difficult to develop operational systems which can sustain long term exposure to these repeated high temperature and pressure peaks/oscillations.

Further, because of the need to block the pressure peaks from upstream components, various valving techniques are being developed to prevent high pressure peaks from traveling upstream to the compressor stage. However, this repeated blocking and unblocking by the valve can itself create unsteady pressure oscillations that can cause less than optimal compressor operation.

Additionally, the use of PDCs in turbine based engines and hybrid engines have been hampered by the coupling of the PDCs to the turbine stage. Because of the high pressure and temperature pulses exhausted by PDCs it has been difficult to optimize the energy from PDCs in existing turbine stages.

Therefore, there exists a need for an improved method of implementing PDCs in turbine based engines and power generation devices, which address the drawbacks discussed above.

### SUMMARY OF THE INVENTION

In an embodiment of the present invention, an engine contains a compressor stage having an outlet through which a compressed flow passes, a pulse detonation combustor stage comprising at least one pulse detonation combustor, where the pulse detonation combustor stage is coupled to the outlet, and a turbine stage coupled to the pulse detonation combustor stage which receives an exhaust from the pulse detonation combustor stage. At least a portion of the at least one pulse detonation combustor is oriented at least one of tangentially and longitudinally with respect a centerline of the engine.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, “engine” means any device used to generate thrust and/or power.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of an exemplary embodiment of the present invention;

FIG. 2A shows a diagrammatical representation of a can-annular arrangement in accordance with an exemplary embodiment of the present invention;

FIG. 2B shows another diagrammatical representation of the can-annular arrangement of FIG. 2A;

FIG. 2C shows a diagrammatical view of a pulse detonation combustor oriented longitudinally with respect to an engine;

FIG. 2D shows a diagrammatical view of a pulse detonation combustor oriented tangentially with respect to an engine; and

FIG. 3 shows diagrammatical representations of two alternative PDC orientations in accordance with exemplary embodiments of the present invention.

### DETAILED DESCRIPTION OF THE INVENTION

The present invention will be explained in further detail by making reference to the accompanying drawings, which do not limit the scope of the invention in any way.

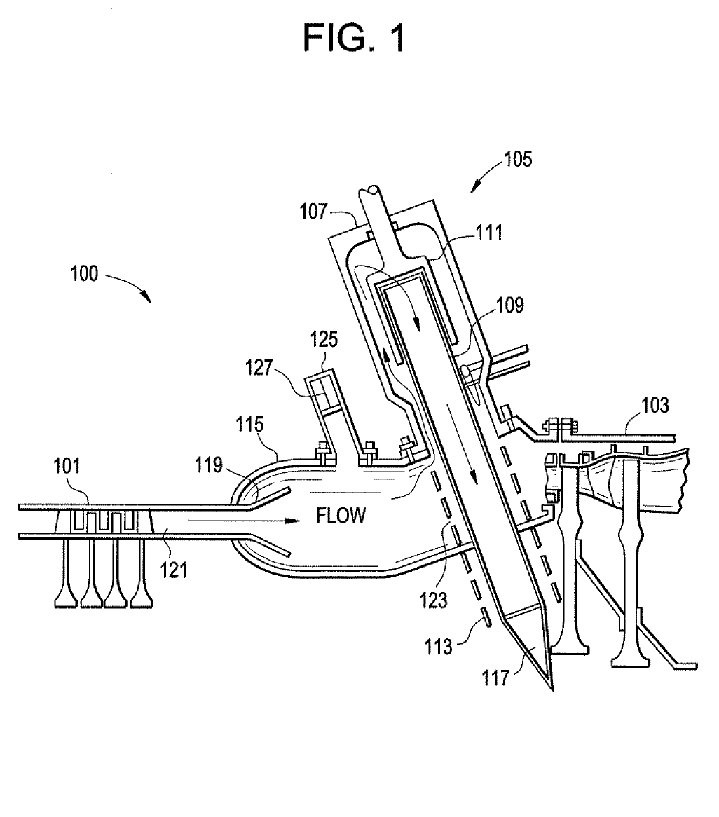

FIG. 1 depicts a portion of an engine 100 in accordance with an embodiment of the present invention. As shown, the engine 100 contains a compressor stage 101 and a turbine stage 103. These stages are configured in any known or conventional way. Positioned downstream of the compressor stage 101 and upstream of the turbine stage 103 is a PDC stage 105. In the exemplary embodiment shown, the PDC stage 105 fully replaces a conventional combustor stage, such that the PDC stage 105 fully provides the energy normally supplied by the combustion stage. However, the present invention is not limited in this regard. Specifically, it is also contemplated that the PDC stage 105 of the present invention is employed with a combustion stage within the engine 105. This would be similar to a hybrid PDC engine type in which a deflagration-based combustion stage is coupled with PDCs to provide additional energy to the system.

Within the PDC stage 105 are a plurality of PDCs 109 which are located within the PDC stage casing 107. As can be seen, the PDCs 109 are annularly positioned within respect to the engine 100. By positioning the PDC stage 105 and its components, as shown, the overall length of the engine 100 is reduced, making the length more commensurate in scope with traditional engine lengths. In traditional implementations the PDCs are positioned fully between the compressor stage 101 and the turbine stage 103, thus greatly increasing the overall length of the engine 100.

Each of the PDCs 109 has a known configuration. The present invention is not limited in this regard. It is contemplated that any known or conventional type of PDC can be employed in the present invention.

In another exemplary embodiment, the PDC stage 105 can contain a mixture of PDCs 109 and deflagration-based combustion devices. Accordingly, embodiments of the present invention are not intended to be limited to applications in which the entire combustion operation is provided by PDCs.

In an exemplary embodiment of the present invention, each of the PDCs 109 contains a PDC inlet valve structure 111. The inlet valve structure 111 allows for the entry of air and/or an air/fuel mixture, where at least some of the air is provided from the compressor stage 101. As shown in FIG. 1, the PDCs 109 are angled longitudinally so that the PDC 109 exhaust flow is directed at the turbine stage 103 at an angle. In an embodiment of the present invention, the PDCs 109 are angled about 45 degrees with respect to the centerline of the engine. In another embodiment, the PDCs 109 are angled between about 0 and about 45 degrees with respect to the centerline. In another exemplary embodiment, the angling is chosen so as to match the velocity triangles appropriate for the rotating blades in the turbine 103. Such a configuration can be optimal for an engine 100 operating in a steady state mode.

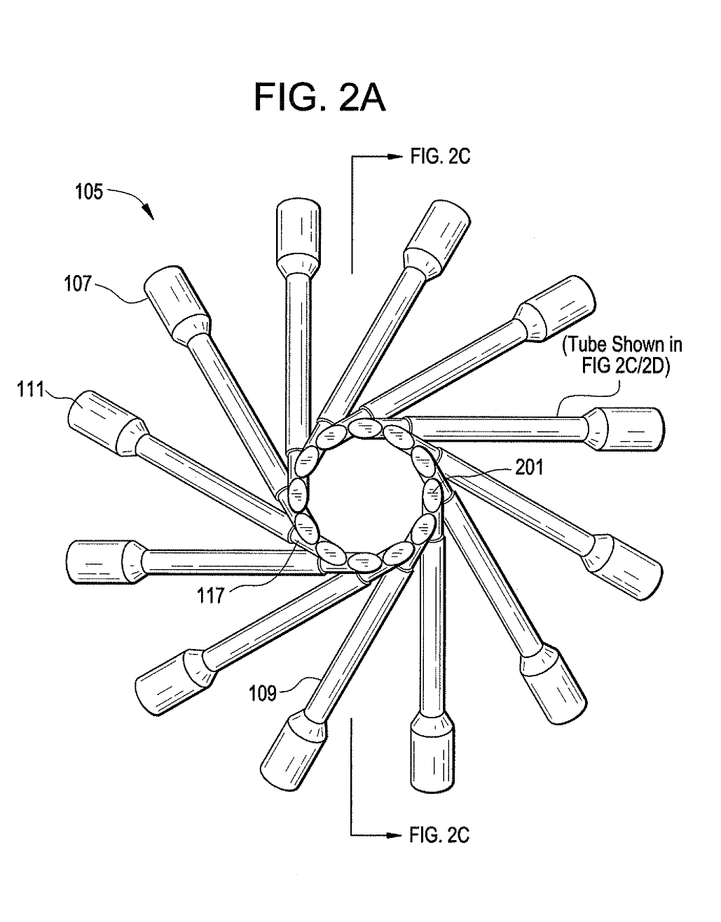

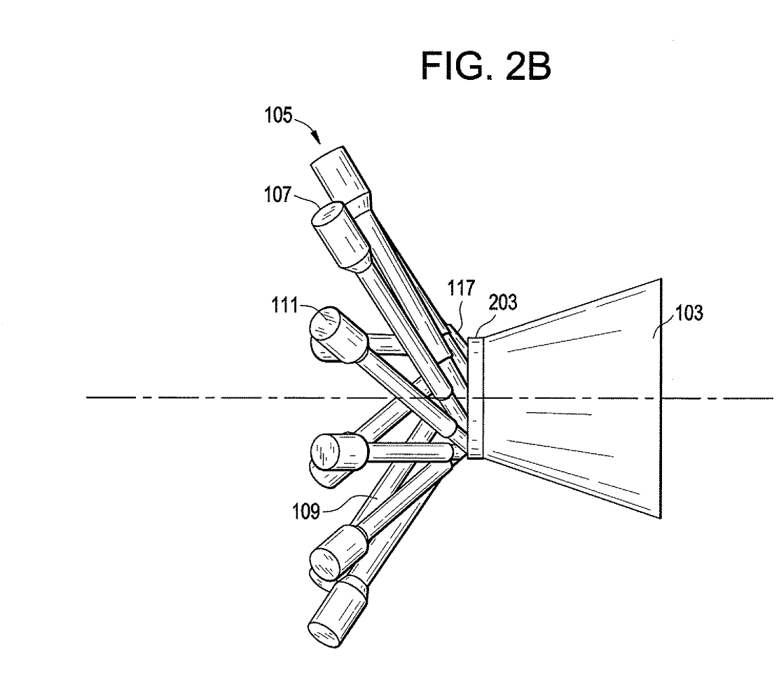

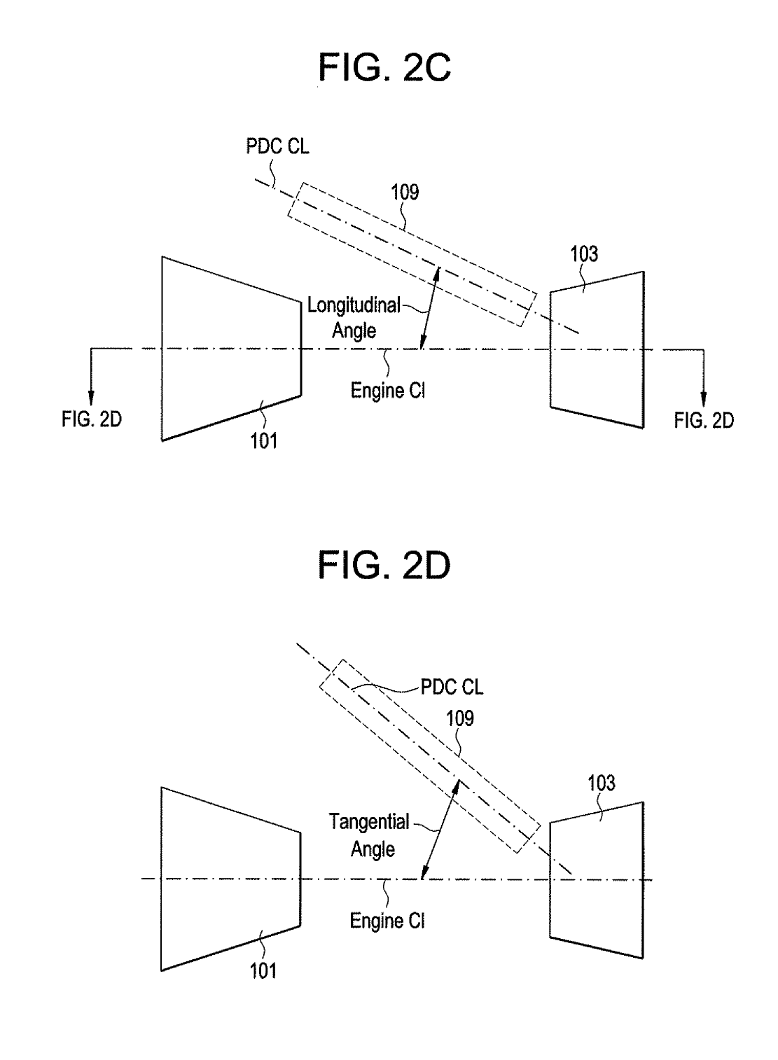

The above discussion, referring to the longitudinally angling of the PDCs 109, is intended to refer to the angling between the centerline of the engine and the centerline of the PDC 109 as the PDC 109 is projected onto the plane of the centerline of the engine 100, when the engine is viewed/oriented longitudinally. That is the respective centerlines of the projected PDC 109 and the centerline of the engine 100 exist in the same plane, but the centerline of the PDC 109 is angled with respect to the centerline of the engine. This can be visually seen in FIG. 1 and FIG. 2C.

FIG. 2C diagrammatically depicts the engine 100 orientated longitudinally and a plane passing vertically through the engine centerline CL. To depict the longitudinal angle of the PDC 109 and for the purposes of this figure, the PDC 109 is projected onto the plane passing through the centerline of the engine 100 in the vertical direction (with respect to FIG. 2C). (Only a single PDC 109 is depicted for clarity). This is done to simply the understanding of the geometry as the PDCs 109 can be oriented around the centerline CL of the engine 100 in a circular type array, as shown in FIG. 2A.

In an additional exemplary embodiment not shown, a portion of the PDCs 109 are angled at a first angle, for example about 45 degrees, and then bend/transition to a second angle as the PDCs approach their ends (i.e., near the turbine 103). In an embodiment of the present invention, the second angle is between about 60 and about 80 degrees. Such an embodiment can be used to optimize space considerations around the engine 100.

As will be discussed in more detail below, in an exemplary embodiment of the present invention, in addition to having the PDCs 109 angled longitudinally with respect to the engine 100, as shown, the PDCs 109 are angled tangentially with respect to the centerline of the engine. This will be discussed further with respect to FIGS. 2A, 2B and 2D, below.

Because of the angling of the PDCs 109, during operation the compressed flow exits the outlet 121 of the compressor stage 101 and is then directed to the inlet valving 111 of the PDCs 109. In the embodiment shown, the flow is turned outward radially outwards towards the valving 111.

It is noted that any known inlet valving 111 structure or configuration can be employed. There is no limitation in this regard. However, in an exemplary embodiment, the valving 111 is configured to minimize or prevent pressure peaks from with the PDCs 109 (created during operation) from exiting the valving 111 and entering the cavity of the casing 107. Further, the timing and operation of the valving is not limiting. In one embodiment, all of the PDCs 109 are operated simultaneously such that their operations are in-sync. In a further exemplary embodiment, the operation of the PDCs is sequenced such that not all PDCs are firing at the same time, but their operation is staggered. Further, the present invention is not intended to be limited by the fuel injection system employed. Known valving controls methods, structure and techniques can be employed in the various embodiments of the present invention. The present invention is not intended to be limited by the valving methodologies employed.

By angling the PDCs 109 as shown and positioning the valving 111 radially away from the engine centerline, the exemplary embodiments of the present invention aid in minimizing the unsteady compressor exit flows experienced in traditional PDC implementations. With this angling, pressure fluctuations which are generated by the PDC 109 can be diffused within the casing 107 prior to reaching the compressor outlet 121. Thus, the exit of the compressor stage 101 “sees” a relatively steady flow, and its operation can be optimized.

Further, by directing the compressor flow radially and forward within the casing 107, cooling of the PDCs 109 is affected. As described earlier, PDC operation generates a considerable amount of heat, such that the walls of a PDC can reach very high temperatures. Various methods have been contemplated for cooling these walls. Many methods require the use of additional cooling structure and/or systems which add cost, weight and complexity to the engine.

In exemplary embodiments of the present invention, the compressor flow is directed forward within the casing 107 and thus along the exterior surfaces of the PDCs 109. Because the flow from the compressor stage 101 is typically relatively cool, this flow acts as a heat exchanger as it flows along the PDC 109 walls up to the inlet valving 111. Moreover, as the flow takes heat from the PDC 109 walls, the flow temperature increases. This aids in the operation of the PDC as an increased air flow temperature can assist in the detonation procedure.

In another exemplary embodiment of the invention, to increase the heat exchange aspects of the walls of the PDCs 109, the walls are configured with vanes or baffles, or the like. This will increase the overall surface area and increase the heat exchange between the PDCs 109 and the flow. Further, these structures (not shown) can be used to direct and otherwise control the flow through the casing 107 to the inlet valving 111.

As shown in FIG. 1, in the depicted embodiment the PDCs 109 are angled with respect to the centerline of the engine 100. By angling the PDCs 109 with respect to the centerline of the engine 100 it is relatively easy to redirect the flow from the outlet 121 to the inlet valving 111.

As shown in FIG. 1, an exemplary embodiment of the present invention contains a diffuser 119 which directs flow from the outlet 121 into the PDC stage 105. The diffuser 119 aids in turning the flow from the outlet 121 into the PDC stage 105 such that the flow transition and redirection is optimized. In an embodiment of the invention, the flow is redirected such that turbulence is minimized.

In a further exemplary embodiment, the PDC stage 105 contains a plenum 115. The plenum 115 is employed to aid in the pressure rise mitigation. Specifically, the plenum 115 provides additional cavity space to aid in the dissipation and/or absorption of pressure fluctuations that are experienced due to the operation of the PDCs 109. As is known, air is a relatively compressible medium, and thus by increasing the overall volume of the PDC stage 105, by adding a plenum 115, the volume of air used to dissipate any pressure fluctuations is increased. It is noted that the plenum configuration and location shown in FIG. 1 is intended to be exemplary and the present invention is not limited to the embodiment shown.

Further, in an alternative exemplary embodiment (as shown in FIG. 1) surrounding the PDCs 109 is a tube shroud 113. The shroud 113 aids in directing flow from the compressor stage 101 to the walls of the PDCs 109 as well as controlling the flow within the area of the plenum 115. Further, the shroud 113 may contain flow control openings 123 which assist in flow direction as well as pressure peak mitigation and/or dissipation. The configuration of the plenum 115, casing 107 diffuser 119 and/or shroud 113 can be optimized, by those of ordinary skill in the art, such that the desired operational and performance characteristics are achieved. Specifically, those of ordinary skill the art are sufficiently capable of optimizing these components to achieve the desired cooling and pressure peak minimization/dissipation to ensure the desired operation of the PDC 109 and the compressor stage 101.

In an alternative embodiment, not expressly shown in the figures, at least some of the air flow into the inlet valving 111 comes from another source then the compressor stage 101. For example, it is contemplated that in embodiments where the engine 100 has a bypass flow, at least some of the bypass flow is also directed into the valving 111. The amount of this additional flow is to be determined based on desired operational and performance characteristics.

In an exemplary embodiment of the present invention, the PDCs 109 are coupled to the turbine stage 103 (typically to a high pressure turbine stage) via nozzles 117. The exact configuration and implementation of the nozzles 117 will vary depending on design and operational parameters. In the exemplary embodiment shown, the nozzles 117 are converging nozzles, whose structure and operation are known. In another embodiment the nozzle 117 is a converging-diverging nozzle. Further, the transition between the nozzles 117 and the turbine stage 103 is a function of the structural and operational parameters of the particular engine 100 in which the present invention is employed. For example, it is contemplated that in some embodiments, each individual PDC 109 will be directly coupled, via its nozzle 117, to the turbine stage 103. However, it is also contemplated that two or more PDCs 109 can be directed into a single manifold structure where their respective flows are mixed, and then the common manifold structure is directed to the turbine stage 103.

Turning now to FIGS. 2A, 2B and 2D, FIG. 2A depicts a cross-section of an exemplary embodiment of a PDC stage 105 looking forward at the PDC stage 105 from the turbine stage 103. In this embodiment, the PDC stage 105 contains twelve PDCs 109 positioned radially around the centerline of the engine 100. Of course, the present invention is not limited to this express embodiment, as various alternatives are contemplated, with varying quantities of PDCs 109.

Further, in the embodiment shown the nozzles 117 have an oval shaped opening 201 through which the PDC 109 exhaust exits and enters the turbine stage 103. However, the opening 201 is not limited in this regard and can be made with any shape or configuration to maximize PDC 109 and/or turbine performance as desired.

As can be seen in FIGS. 2A/2D, in an exemplary embodiment of the present invention, the PDCs 109 are angled tangentially with respect to the centerline CL of the engine. This angling allows the PDC 109 exhaust to enter the turbine stage 103 having a rotational aspect. This rotation assists in improving the operation and performance of the turbine stage. Thus, in an exemplary embodiment of the present invention, the PDCs 109 are angled longitudinally such that the inlet portions 111 are physically forward of the nozzles 117 (as shown in FIG. 1 and FIG. 2B), and are angled to be oriented tangentially with respect to the engine centerline CL (FIGS. 2A/2D).

The above discussion, referring to the tangential angling of the PDCs 109, is intended to refer to the angling between the centerline of the engine and the centerline of the PDC 109 as the PDC 109 is projected onto a plane of the centerline of the engine 100 which is perpendicular to the plane through which the longitudinal angle is measured. That is the respective centerlines of the projected PDC 109 and the centerline of the engine 100 exist in the same plane, but the centerline of the PDC 109 is angled with respect to the centerline of the engine. This can be visually seen in FIGS. 2A, 2B and FIG. 2D.

FIG. 2D diagrammatically depicts the engine shown in FIG. 2C but looking down at the engine 100. By looking down at the centerline CL of the engine a plane is shown which is perpendicular, or normal, to the vertical plane shown in FIG. 2C. The plane shown in FIG. 2D, like that in FIG. 2C, is passing through the engine centerline CL and the CL of the projected image of the PDC 109 onto that plane. To depict the tangential angle of the PDC 109 and for the purposes of this figure, the PDC 109 is projected onto the plane passing through the centerline of the engine 100. This is done to simply the understanding of the geometry as the PDCs 109 can be oriented around the centerline CL of the engine 100 in a circular type array, as shown in FIG. 2A.

Accordingly, the tangential angle is measured in a plane which is perpendicular or normal to the plane in which the longitudinal angle is measured for the PDCs 109. It is also noted that the present invention, is not limited to using the absolute horizontal and vertical of an engine to define the planes. That is, it is contemplated that the planes can be rotated/oriented about the engine centerline for each respective PDC 109. This is particularly the case in the embodiment shown in FIGS. 2A/2B, in which the PDCs 109 are oriented in a circular array about the engine centerline CL.

The PDCs 109 can be tangentially angled such that the angle is between about 0 and 90 degrees. In another embodiment, the tangential angle is between about 10 and about 90 degrees. In a further embodiment, the angle A is between about 40 and about 90 degrees.

In the embodiment shown in FIGS. 2A, 2B the tangential and longitudinal angles for the PDCs 109 are the same. However, in additional embodiments of the present invention, at least some of the PDCs 109 are angled such that either one, or both, of the tangential and longitudinal angles differ. For example, in an embodiment of the invention, half of the PDCs 109 are angled such that the tangential angle is about 90 degrees, and the other half of the PDCs have a tangential angle of about 75 degrees. It is noted that this example is not intended to be limiting, but is merely exemplary. Those of ordinary skill in the art are capable of determining and optimizing the desired angling and configuration for various design and performance criteria.

FIG. 2B diagrammatically shows the PDC stage 105 from the side of the engine 100. In the embodiment shown, the PDC stage 105 is coupled to a turbine manifold 203 which is coupled to the turbine stage 103 (for example a high pressure turbine). The manifold 203 can be of any configuration to optimize the performance of the PDC stage 105 and the turbine stage 103. In another exemplary embodiment, the manifold 203 is not employed and thus the nozzles 117 are coupled directly to the turbine stage 103.

In another exemplary embodiment of the invention, it is contemplated that at least some of the PDCs 109 are operated out-of phase with each other. In such an embodiment, because the PDCs 109 are directed to the turbine a relatively constant flow is directed into the turbine stage 103 so as to minimize the adverse affects of extreme pressure spikes (from all PDCs 109 firing at the same time) into the turbine stage 103. It is also contemplated that in the PDC stage 105 some PDCs 109 are employed and some standard combustion devices are employed. Thus, the standard combustion devices will provide constant flow, whereas the PDCs 109 will provide the desired PDC flow. The exact operation and mixture of these components is a function of the desired operational and performance characteristics of the engine 100, and those of ordinary skill in the art are capable of choosing and implementing their desired configuration.

In exemplary embodiments of the present invention, the PDCs 109 have relatively small diameters. For example, the PDCs can have diameters in the range of about 2 to 4 inches. By using relatively small diameters, the internal stresses within an individual tube is minimized, thus reducing the overall thickness of the PDC 109 tube walls. Additionally, the overall length of the PDC 109 is reduced allowing for a compact PDC stage 105. This is because as the diameter of the PDC 109 increases, the overall length of the PDC needs to increase to allow for proper detonation operation.

Because of the angling of the PDCs 109 as discussed herein, (both longitudinally and/or tangentially) embodiments of the present invention allow for the elimination of the turbine nozzle (also commonly referred to as a turbine inlet or turbine stator portion) which is normally present in the turbine stage of the engine. As is known, in a standard turbine engine configuration the combustor flow is coaxial with the engine centerline as it enters the turbine stage of the engine. The turbine nozzle portion of a turbine stage is used to turn the flow entering from the combustion stage to be tangential with the engine centerline. Typically, a turbine nozzle portion turns the combustor flow about 70 degrees so that the flow is more tangential than axial in the turbine stage. However, the use of a turbine nozzle portion causes a significant pressure drop in the flow. This pressure drop is disadvantageous. Additionally, a considerable amount of the engine cooling flow must be used to cool the turbine nozzle.

By angling the PDCs 109 of the present invention longitudinally and/or tangentially as described herein, embodiments of the present invention allow for the removal of a turbine nozzle portion from the turbine stage. In such an embodiment, the PDCs 109 are angled (longitudinally and/or tangentially) so that the exhaust of the PDCs 109 enter the turbine stage at an angle which is appropriate for the rotating portions of the turbine stage. In such an embodiment the exit nozzles 117 of the PDCs 109 exhaust directly into the rotating portions of the turbine stage 103. This eliminates the pressure drop associated with the turbine nozzle and eliminates the need to use substantial amounts of the engine cooling flow to cool the turbine nozzle. In such an embodiment, the angling of the PDCs 109 should be such that their exhaust flow enters the turbine stage 103 at the appropriate angle. In another exemplary embodiment, the turbine nozzle portion is present but, because of the PDC 109 angling, the angling imparted by the turbine nozzle can be less than typically required. That is, in an exemplary embodiment, the desired turning of the flow into the turbine stage 103 can be effected by a combination of the angling of the PDCs 109 and a turbine nozzle.

Turning again to FIG. 1, the plenum 115 has a resonant cavity 125 coupled to it. The resonant cavity 125 can be either active or passive and provides additional damping for the pressure oscillations that can be experienced. In an exemplary embodiment the resonant cavity 125 contains a dampening structure 127 which oscillates as pressure within the resonant cavity 125 and plenum 115 increases and decreases. Thus the dampening structure 127 effectively increases and decreases the volume of the plenum 115 to effectively absorb the pressure oscillations experienced. Thus, the compressor flow from the outlet 121 sees little or no pressure oscillations, which allows the compressor stage 101 to operate normally and optimally. The dampening structure 127 can be any mechanical type system (such as an oscillating damped position), or can be any other type of dampening mechanism (such as a viscous liquid), or an acoustic type damper (quarter-wave damper).

In a quarter-wave damper the length of the cavity is chosen to be a quarter of the wavelength of the oscillation that is to be dampened. As waves enter the tube and reflect back, their phase is effectively shifted and they destructively interfere with the remaining waves in the plenum 115. This reduces the amplitude of the oscillations within the plenum 115 at that given frequency. In an exemplary embodiment of the present invention, a plurality of quarter-wave tubes are employed having different sizes so that different frequencies of oscillation within the plenum 115 can be reduced or removed. In a further exemplary embodiment the quarter-wave tubes have an adjustable piston structure (such as item 127) which allows the length of the tubes to be adjusted. In such an embodiment, the adjustment of the pistons, and thus the tube length, can be adjusted actively (i.e., during operation) to tune the dampening to the oscillations being experienced during engine operation.

It will be appreciated that the orientation and configuration of the components employed is a function of the design and operational parameters of the engine and turbine stages employed. Those of ordinary skill in the art are capable of determining and implementing the optimal configuration, taking into account the necessary parameters and design criteria.

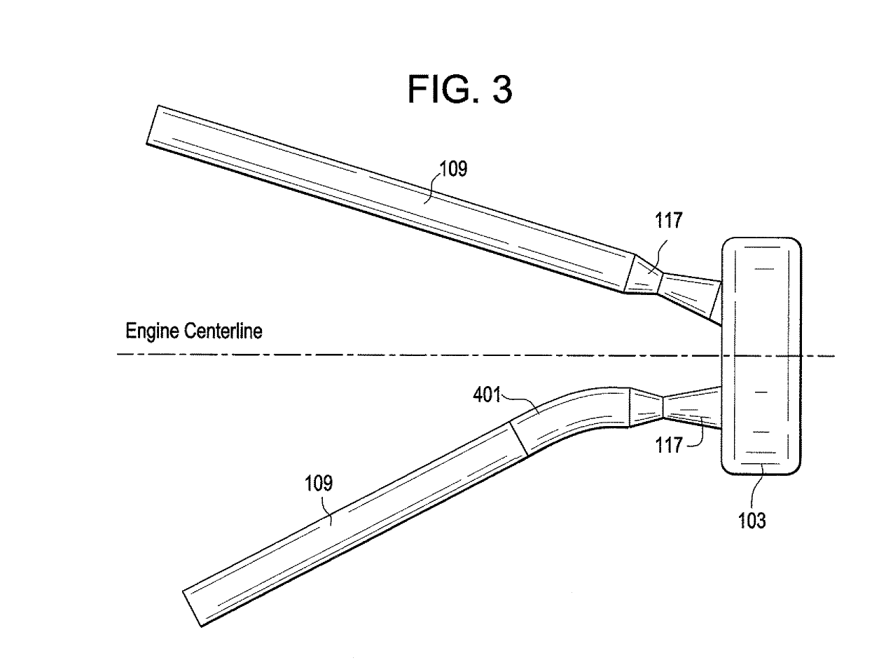

FIG. 3 depicts alternative configurations regarding the orientation of the PDCs 109 with respect to the orientation of the PDC exhaust into the turbine stage 103 (simply depicted). As shown in the upper portion of this figure (which is also consistent with FIG. 1) the exhaust gas of the PDC 109 is directed into the turbine stage 103 at an angle with respect to the centerline of the engine. Of course, it is noted that even though the nozzle 117 is shown directly coupled to the turbine stage 103, this is not intended to be limiting. This depiction is merely intended to be representative of the angular orientation. Of course a manifold structure may be used as well as any other appropriate means to direct the flow into the turbine stage 103. Alternatively, as described above, the nozzle 117 can be coupled directly to the rotating portions of the turbine stage 103, eliminating the need for a turbine nozzle.

In the bottom portion of this figure, an alternative embodiment is shown. In this embodiment, although the PDC 109 is angled with respect to the centerline of the engine, the exhaust of the PDC 109 is directed parallel to the centerline as it enters the turbine stage 103. In this embodiment, a direction manifold structure 401 is employed to change the direction of the flow so as to be effectively parallel with the centerline. In this embodiment, the angle of the PDC 109, with respect to the centerline of the engine 100 should be as small as possible, to reduce the heat load on the direction manifold structure 401.

It will be appreciated that the orientation and configuration employed is a function of the design and operational parameters of the engine and turbine stages employed. Those of ordinary skill in the art are capable of determining and implementing the optimal configuration, taking into account the necessary parameters and design criteria.

It is also noted that the above discussions regarding “flow” and “flow direction” are intended to be general in nature. It is certainly understood and appreciated that the many flows involved in systems incorporating the present invention can be turbulent and have infinite internal flow directions. In recognizing this, when flow is described as “parallel,” for example, that is understood to mean a general flow direction.

It is noted that although the present invention has been discussed above specifically with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. An engine, comprising:
a compressor stage having an outlet through which a compressed flow passes;
a pulse detonation combustor stage comprising at least one pulse detonation combustor, wherein said pulse detonation combustor stage is coupled to said outlet; and
a turbine stage coupled to said pulse detonation combustor stage which receives an exhaust from said pulse detonation combustor stage,
wherein at least a portion of said at least one pulse detonation combustor is oriented at least one of tangentially and longitudinally with respect a centerline of the engine.

2. The engine of claim 1, wherein said portion of said at least one pulse detonation combustor is angled both tangentially and longitudinally.

3. The engine of claim 1, wherein said at least one pulse detonation combustor is oriented tangentially with respect to said centerline such that a tangential angle between a centerline of said at least one pulse detonation combustor and said engine centerline is up to 90 degrees.

4. The engine of claim 1, wherein said at least one pulse detonation combustor is oriented tangentially with respect to said centerline such that a tangential angle between a centerline of said at least one pulse detonation combustor and said engine centerline is in the range of 10 to 90 degrees.

5. The engine of claim 1, wherein said at least one pulse detonation combustor is oriented tangentially with respect to said centerline such that a tangential angle between a centerline of said at least one pulse detonation combustor and said engine centerline is in the range of 40 to 90 degrees.

6. The engine of claim 1, wherein said at least one pulse detonation combustor is oriented longitudinally with respect to said centerline such that a longitudinal angle between a centerline of said at least one pulse detonation combustor and said engine centerline is in the range of 0 to 45 degrees.

7. The engine of claim 1, wherein said pulse detonation combustor stage further comprises a plenum coupled to said outlet and said at least one pulse detonation combustor.

8. The engine of claim 7, wherein said plenum comprises at least one resonant cavity having either an active or passive pressure dampening structure.

9. The engine of claim 1, wherein said pulse detonation combustor stage comprises a plurality of pulse detonation combustors, wherein at least some of said pulse detonation combustors are angled either tangentially or longitudinally different from other of said pulse detonation combustors.

10. The engine of claim 1, wherein said at least one pulse detonation combustor comprises an inlet portion through which at least a portion of said compressed flow passes and said portion of said compressed flow is directed radially away from said centerline of said engine to said inlet portion from said outlet.

11. The engine of claim 1, wherein said turbine stage does not contain a turbine nozzle portion.

12. An engine, comprising:
a compressor stage having an outlet through which a compressed flow passes;
a pulse detonation combustor stage comprising at least one pulse detonation combustor, wherein said pulse detonation combustor stage is coupled to said outlet; and
a turbine stage coupled to said pulse detonation combustor stage which receives an exhaust from said pulse detonation combustor stage,
wherein at least a portion of said at least one pulse detonation combustor is angled both longitudinally and tangentially with respect a centerline of the engine.

13. The engine of claim 12, a tangential angle between a centerline of said at least one pulse detonation combustor and said engine centerline is up to 90 degrees.

14. The engine of claim 12, wherein a tangential angle between a centerline of said at least one pulse detonation combustor and said engine centerline is in the range of 10 to 90 degrees.

15. The engine of claim 12, wherein a tangential angle between a centerline of said at least one pulse detonation combustor and said engine centerline is in the range of 40 to 90 degrees.

16. The engine of claim 12, wherein a longitudinal angle of said at least one pulse detonation combustor with respect to said engine centerline is in the range of 0 to 45 degrees.

17. The engine of claim 12, wherein said pulse detonation combustor stage further comprises a plenum coupled to said outlet and said at least one pulse detonation combustor.

18. The engine of claim 17, wherein said plenum comprises at least one resonant cavity having either an active or passive pressure dampening structure.

19. The engine of claim 12, wherein said pulse detonation combustor stage comprises a plurality of pulse detonation combustors, wherein at least some of said pulse detonation combustors are either tangentially or longitudinally oriented different from other of said pulse detonation combustors.

20. The engine of claim 12, wherein said at least one pulse detonation combustor comprises an inlet portion through which at least a portion of said compressed flow passes and said portion of said compressed flow is directed radially away from said centerline of said engine to said inlet portion from said outlet.

21. The engine of claim 12, wherein said turbine stage does not contain a turbine nozzle portion.

22. An engine, comprising:
a compressor stage having an outlet through which a compressed flow passes;
a pulse detonation combustor stage comprising at least one pulse detonation combustor, wherein said pulse detonation combustor stage is coupled to said outlet; and
a turbine stage coupled to said pulse detonation combustor stage which receives an exhaust from said pulse detonation combustor stage,
wherein at least a portion of said at least one pulse detonation combustor is longitudinally angled with respect to a centerline of the engine such that the angle is in the range of 0 to 45 degrees and angled tangentially with respect said centerline such that the tangential angle is up to 90 degrees.
